(19) United States
(12) Patent Application Publication
(10) Pub. No.: US 2024/0205956 A1
(43) Pub. Date: Jun. 20, 2024

(54) DYNAMIC PUCCH FORMAT CONFIGURATION USING MACHINE LEARNING

(71) Applicant: Telefonaktiebolaget LM Ericsson (publ), Stockholm (SE)

(72) Inventors: Soma Tayamon, Stockholm (SE); Euhanna Ghadimi, Bromma (SE)

(73) Assignee: Telefonaktiebolaget LM Ericsson (publ), Stockholm (SE)

(21) Appl. No.: 18/556,478

(22) PCT Filed: Apr. 22, 2021
(86) PCT No.: PCT/EP2021/060488

§ 371 Date: Oct. 20, 2023

(51) Int. Cl. H04W 72/542; H04W 24/02; H04W 72/21

(52) U.S. Cl. CPC H04W 72/542; H04W 24/02; H04W 72/21

(57) ABSTRACT

A method (900) performed in a radio access network (RAN) (200) for Physical Uplink Control Channel (PUCCH) format configuration of a user equipment (UE) (102) currently being served by a network node (104) in the RAN. The method includes obtaining (902) information, the information comprising at least one of: UE information about the UE currently being served by the network node in the RAN or network information about the RAN currently serving the UE. The method includes processing (904) the obtained information using a machine learning model (300, 400A, 400B, 500). The method includes selecting (906) a PUCCH format configuration from a plurality of PUCCH format configurations based on the processing. The method includes determining (908) whether to initiate a configuration of the UE to the selected PUCCH format configuration.

### TECHNICAL FIELD

Disclosed are embodiments related to PUCCH format selection and dynamic PUCCH format using machine learning.

### BACKGROUND

Physical Uplink Control Channel (PUCCH) is used in new radio (NR) and also in LTE networks to carry Uplink Control Information (UCI). Such information includes the Hybrid Automatic Repeat Request (HARQ) feedback such as (Acknowledgement) ACK and (Not an Acknowledgement) NACK messages, Channel State Information (CSI) and Scheduling Requests (SR). The HARQ feedback is used to notify the base station about the data transmitted on the downlink. CSI report may include information regarding the quality of UE's channel referred to as Channel Quality Indicator (CQI), the precoding used at UE referred to as Precoding Matrix Indicator (PMI), or rank preferable by the UE referred to as Rank Indicator (RI). The SR is used by the UE to request communication resources on Physical Uplink Shared Channel (UPSCH) to transmit data at uplink direction. Depending on what kind of UCI is carried by PUCCH, it is classified into various formats.

In LTE, the base sequences are configured per cell using an identity provided as part of the SI. Furthermore, a sequence hopping, where the base sequence varies on a slot-by-slot basis, can be used to randomize the interference between different cells.

Moreover, in LTE, in order to maintain the contiguity of the Physical Resource Blocks (PRBs) required for uplink data transfer, PUCCH spans over few PRBs at the boundary of the bandwidth.

In NR, however, a more flexible PUCCH pattern is configurable in order to support different applications and use cases promised in 5G (such as URLLC and mobile Broadband). In particular, FIGS. 1A-B are block diagram showing two possible types of physical uplink control channels, according to some embodiments. FIG. 1A illustrates long duration NR PUCCH and FIG. 1B illustrates a short duration NR PUCCH. In short duration NR PUCCH, the control channel spans over 1 or 2 symbols and can coincide with downlink or uplink data channels in a Time Division Multiplex (TDM) manner. Fast HARQ feedback can be enabled in this scheme by placing PUCCH at last symbol(s) of one time slot.

In 5G NR, different PUCCH formats are available for different use cases and scenarios. The following table presents the different formats for different UCI payloads and the amount of resources allocated for each:

TABLE 1
PUCCH formats defined by 3GPP (38.300)

| | | Length | | |
|---|---|---|---|---|
| PUCCH | | in OFDM | Number | |
| Format | Short/Long | symbols | of bits | Description (based on 38.300, § 5.3.3) |
| 0 | Short | 1-2 | ≤2 | Short PUCCH of 1 or 2 symbols with small |
| | | | | UCI payloads of up to two bits with UE |
| | | | | multiplexing in the same PRB. |
| | | | | The short PUCCH format of up to UCI bits is |
| | | | | based on sequence selection. |
| 1 | Long | 4-14 | ≤2 | Long PUCCH of 4-14 symbols with small UCI |
| | | | | payloads of up to two bits with multiplexing in |
| | | | | the same PRB. |
| | | | | The long PUCCH formats time-multiplex the |
| | | | | UCI and DMRS. Frequency hopping is |
| | | | | supported for long PUCCH formats. |
| | | | | Long PUCCH formats can be repeated over |
| | | | | multiple slots. |
| 2 | Short | 1-2 | >2 | Short PUCCH of 1 or 2 symbols with large |
| | | | | UCI payloads of more than two bits with no |
| | | | | multiplexing in the same PRB. |
| | | | | The short PUCCH format of more than two |
| | | | | UCI bits frequency multiplexes UCI and |
| | | | | DMRS. |
| 3 | Long | 4-14 | >2 | PUCCH Format 3 is for large UCI payload |
| | | | | with no multiplexing capacity in the same PRB |
| | | | | The long PUCCH formats time-multiplex the |
| | | | | UCI and DMRS. Frequency hopping is |
| | | | | supported for long PUCCH formats. |
| | | | | Long PUCCH formats can be repeated over |
| | | | | multiple slots. |
| 4 | Long | 4-14 | >2 | PUCCH format 4 is intended for moderate |
| | | | | UCI payload and some multiplexing capacity in |
| | | | | one PRB. |
| | | | | The long PUCCH formats time-multiplex the |
| | | | | UCI and DMRS. Frequency hopping is |
| | | | | supported for long PUCCH formats. |
| | | | | Long PUCCH formats can be repeated over |
| | | | | multiple slots. |

Different PUCCH durations (short vs long) are useful in different scenarios and use cases, in use cases with low coverage need, using short PUCCH format is beneficial as it does not occupy too many resources, and the remaining resources can be utilized by the PUSCH and improve UL throughput. Short PUCCH however, provides low coverage and is not useful for UEs that are on the cell edge.

In the simplest solution, the UE is assigned certain PUCCH resources at cell setup without any consideration to the UE conditions. The number of symbols dedicated to PUCCH resources are often pre-determined and fixed without consideration to UE specific needs and requirements.

In cases where the UE is close to the cell center, a short PUCCH format might be of higher interest to improve UL throughput, and when the UE is on the cell edge, long PUCCH format, with highest number of symbols might be more beneficial.

### SUMMARY

Certain challenges presently exist in current assignment of PUCCH resources for UEs. For example, the current predefined format of PUCCH is inefficient in a sense because it is one solution for all cases which might not be proper for every UE. For instance within a long PUCCH format, longer symbol length (e.g., format 3 or 4 with 10 to 14 symbols) is preferred for a UE at cell edge (with poor radio conditions) from coverage perspective whereas a UE at cell center (with good radio conditions) would benefit from shorter PUCCH symbol length for capacity increasing In addition, there is a lack of adapting PUCCH format based on communication network conditions experienced at UE. These network conditions include received signal quality, interference, coverage, traffic load, mobility, etc. Finally, the current fixed format of PUCCH does not consider dynamic changes in communication networks, such as dynamic patterns in traffic and user loads, interference patterns, time of days, etc.

According to some embodiments, a machine learning technique is proposed for dynamic and per UE PUCCH selection for NR networks. The technique utilizes the information received from the UE and/or information from the network to choose a PUCCH format that optimizes a predefined network KPI (e.g., uplink throughput, coverage, latency). The selection of the PUCCH format is done by a machine learning algorithm that receives the information from the UE and network and selects one of the PUCCH formats based on an algorithm that is trained based on information received from the UE and the network.

Aspects of the present disclosure accordingly cover a dynamic PUCCH configuration in which the PUCCH format for a UE is decided on the go based on the UE and network conditions. In particular, after the UE is in the RRC connected mode, certain measurements may be obtained and used for modifying the PUCCH configuration in an RRC reconfiguration mechanism. PUCCH format selection can be initiated either by the UE or the network node. The network node then decides whether to change the PUCCH format based on a ML technique. The PUCCH format change decision is then signaled to the UE.

In some embodiments, the following steps describe the PUCCH format selection procedure.
1. The network node receives information from the UE and/or the network to be used for PUCCH format selection.
2. The network node (e.g., eNB, gNB) decides whether to change PUCCH format.
3. The network node issues RRC reconfiguration (in case of changed PUCCH format).
4. The network node calculates the feedback signal measuring the quality of previously configured PUCCH format based on measurements from the UE and the network.
5. Return to step 1 as needed.

There are a number of advantages to the PUCCH configuration techniques described herein, including, for example: efficient utilization of communication resources (use efficiently for uplink and downlink control and data channels), adaptive allocation of PUCCH based on dynamic changes in network, and improved performance (throughput, delay, coverage)

Accordingly, a PUCCH format selection procedure is provided that adapts to dynamic changes of the network and the UE. This solution may allow for optimized allocation of uplink resources in live networks. A solution which does not exist in current network implementations.

In one aspect, a method performed in a radio access network (RAN) for Physical Uplink Control Channel (PUCCH) format configuration of a user equipment (UE) currently being served by a network node (104) in the RAN is provided. The method includes the step of obtaining information, the information comprising at least one of: UE information about the UE currently being served by the network node in the RAN or network information about the RAN currently serving the UE. The method includes the step of processing the obtained information using a machine learning model. The method includes the step of selecting a PUCCH format configuration from a plurality of PUCCH format configurations based on the processing. The method includes the step of determining (908) whether to initiate a configuration of the UE to the selected PUCCH format configuration.

In another aspect there is provided a method performed in a radio access network for training a machine learning model to select a Physical Uplink Control Channel (PUCCH) format configuration of a user equipment currently being served by a network node in the RAN. The method includes the step of obtaining a plurality of training samples, wherein each training sample comprises a selected PUCCH format selection, input information comprising at least one of: UE information about the UE or network information about the RAN, a measured key performance indicator (KPI) after configuring the UE with the PUCCH format selection, and one or more parameters related to an exploration strategy used at a time of selection of the selected PUCCH format selection. The method includes the step of processing the training samples to determine one or more updated values to one or more model parameters of the machine learning model. The method includes the step of updating the one or more model parameters of the machine learning model with the one or more updated values.

In another aspect there is provided a network node, where the network node is configured to perform the methods. In another aspect there is provided a computer program comprising instructions which when executed by processing circuitry of a network node causes the network node to perform the methods. In another aspect there is provided a carrier containing the computer program, where the carrier is one of an electronic signal, an optical signal, a radio signal, and a computer readable storage medium.

In yet another aspect, there is provided a method performed by a user equipment (UE) in a radio access network (RAN) for Physical Uplink Control Channel (PUCCH) format configuration of the UE. The method includes the step of performing (1102) a measurement. The method includes the step of determining that the measurement falls outside a predetermined threshold. The method includes the step of transmitting a first message to a network node in the RAN, the first message comprising a measurement report comprising the measurement. The method includes the step of receiving a second message from the network node, the second message comprising a selected PUCCH format based on the measurement report. The method includes the step of configuring a transmission of a signal to the RAN according to the selected PUCCH format.

In another aspect there is provided a user equipment, where the user equipment is configured to perform the method. In another aspect there is provided a computer program comprising instructions which when executed by processing circuitry of a user equipment causes the network node to perform the method. In another aspect there is provided a carrier containing the computer program, where the carrier is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 is a block diagram illustrating two types of physical uplink control channels, according to some embodiments.

FIG. 2 is a generalized block diagram of a UE in communication with a network node in a radio access network.

FIG. 3 is a flowchart illustrating a process according to an embodiment.

FIG. 4A is a flowchart illustrating a process according to an embodiment.

FIG. 4B is a flowchart illustrating a process according to an embodiment.

FIG. 5 is a flowchart illustrating a process according to an embodiment.

FIG. 6 is a flowchart illustrating a process according to an embodiment.

FIG. 7 is a flowchart illustrating a process according to an embodiment.

FIG. 8 is a flowchart illustrating a process according to an embodiment.

FIG. 9 is a flowchart illustrating a process according to an embodiment.

FIG. 10 is a flowchart illustrating a process according to an embodiment.

FIG. 11 is a flowchart illustrating a process according to an embodiment.

FIG. 12 is a block diagram of an apparatus according to an embodiment.

FIG. 13 is a schematic block diagram of an apparatus according to an embodiment.

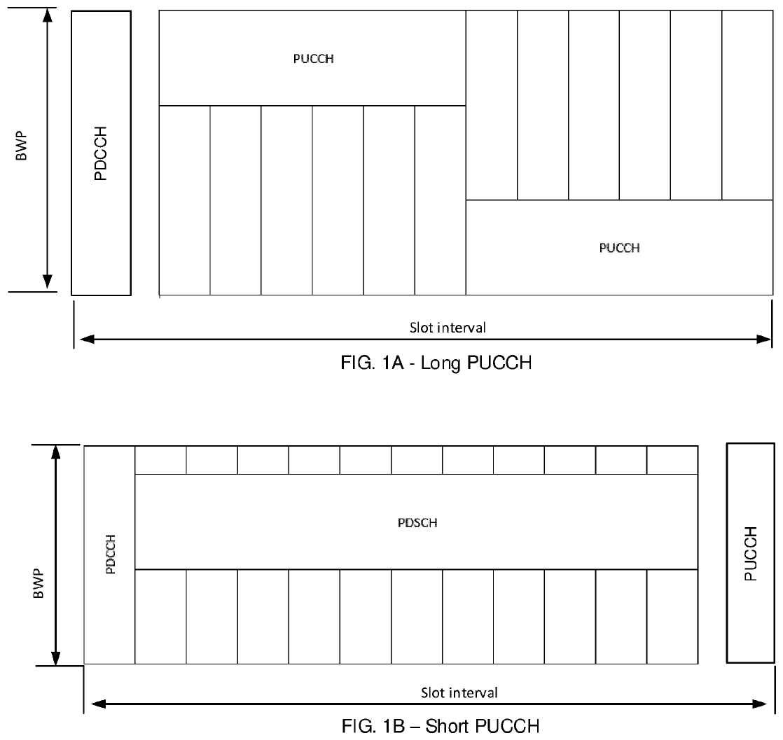

### DETAILED DESCRIPTION

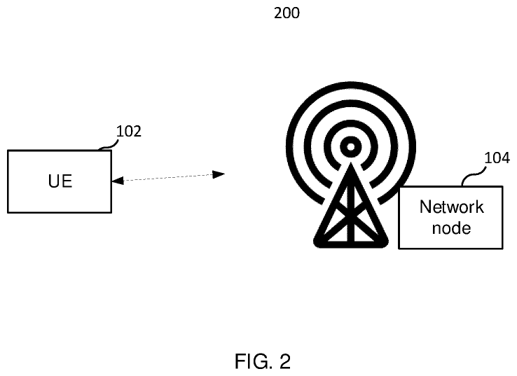

FIG. 2 is a generalized block diagram of a UE in communication with a network node in a radio access network. As shown in FIG. 2, a UE 102 is in communication with a network node 104 in radio access network 200. The UE may be, for example, any device used by an end-user to communicate, such as a mobile device, tablet, or other computing device. The network node 104 may be, for example, an eNB (LTE) and/or a gNB (NR). The radio access network 200 may be a 3GPP-type cellular network. While only a single UE 102 and a network node 104 are illustrated in this example, the disclosed embodiments are equally applicable to a situation where network 200 includes a plurality of UEs and/or network nodes.

According to some embodiments, dynamic PUCCH configuration may be initiated by the UE at connected mode. The UE (102) can request a reconfiguration of the PUCCH configuration, and the gNB (104) decides whether to change the configuration. The network node may grant the PUCCH format change in which case, the decision will be signaled to the UE.

According to some embodiments, a machine learning technique is used for dynamic and per UE PUCCH selection for NR networks. The technique utilizes the information received from the UE and/or information from the network to choose a PUCCH format that optimizes a predefined network KPI (e.g., uplink throughput, coverage, latency). The selection of the PUCCH format may be done by a machine learning algorithm that receives the information from the UE and/or network and selects one of the PUCCH formats based on an algorithm that is trained based on information received from the UE and the network.

The PUCCH format selection may be initiated in two alternative ways—one by the UE (102) and a second by the network node (104).

In the first case, after the UE is the RRC connected mode, certain measurements may be obtained and used for modifying the PUCCH configuration in an RRC reconfiguration mechanism. Dynamic PUCCH format selection initiated by the UE may be performed as follows:
1. UE performs measurements and checks thresholds for PUCCH format triggering
2. UE sends a measurement report containing the UE measurement information related for PUCCH format selection to the network node
3. The network node decides whether to change PUCCH format.
4. The network node issues RRC reconfiguration (in case of changed PUCCH format).
5. The network node calculates the feedback signal measuring the quality of previously configured PUCCH format based on measurements from the UE and the network.
6. Return to step 1.

In an alternative case, the network node can initiate the PUCCH format selection based on the UE measurements available at the network node. In an embodiment, the UE information is received from a second network node. An example includes the handover mechanism in which the UE information is received by the target node from the source network node. Dynamic PUCCH format selection initiated by the network node may be performed as follows:
1. The network node (e.g., eNB, gNB) receives or maintains the UE information useful for PUCCH format selection.
2. The network node decides whether to change PUCCH format.
3. The network node issues RRC reconfiguration (in case of changed PUCCH format)
4. The network node calculates the feedback signal measuring the quality of previously configured PUCCH format based on measurements from the UE and the network.
5. Return to step 1.

### UE Thresholds for PUCCH Reconfiguration

According to some embodiments, the UE devises certain thresholds for PUCCH format reconfigurations. For example, UE may use one or more of the following metrics/KPIs.

t_rsrp_values: it may contain a set of values within a certain range of RSRP values. Normally, the current RSRP value falls in between two of the threshold values. When the RSRP measurement values exceeds the current threshold, then a measurement report might be triggered. In one embodiment, the RSRP and/or the threshold values are converted to linear domain.

t_delta_distance: Delta of the RSRP in dB or linear domain. This metric represents a magnitude of value related to the distance between the gNB and the UE. If the difference between two consecutive RSRP measurements exceed the delta value, the MR is triggered.

t_tpt_bsr: A threshold based on compound relation of throughput vs buffer (e.g., Buffer Status Report (BSR)). This is to evaluate the throughput and the need for allocation of PUCCH resources. For instance, a binary threshold for determining either UE has high or low throughput can be combined with another binary threshold measuring the low or high BSR. For instance, if UE throughput changed from high to low while BSR threshold has not changed (e.g., it stays as high). In such condition, an MR might be triggered. To summarize, here are some examples how the threshold might be defined: (1) Low throughput, high BSR.

Throughput changes from high to low and BSR is high, then the t_tpt_bsr becomes true. (2) High throughput, low BSR: if throughput is high and BSR is low then t_tpt_bsr becomes true. This is to cover the case in which long PUCCH is configured and by changing it to short format would optimize the resources for data channel.

t_congestion: A threshold that indicates the congestion situations in uplink direction. This threshold can be defined, for instance, as a value between [0,1] defined based on uplink PRB utilization (a metric that measures how much percentage of PRBS allocated for uplink is actually used or allocated to different users). Moreover, the percentage of PRBs utilized within PDCCH due to uplink traffic (e.g., the scheduling grants) can be used to define the congestion threshold.

### Selection of the PUCCH Configuration

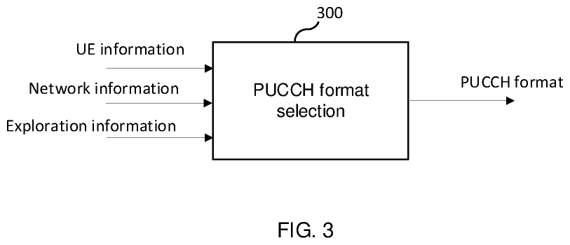

The embodiments disclosed herein utilize a machine learning algorithm or model to decide the PUCCH format based on input information from the user device or the network nodes. In particular, FIG. 3 is a flowchart illustrating a process according to an embodiment. FIG. 3 illustrates a PUCCH format selection algorithm that may take in one or more of UE information, network information, and/or exploration as inputs in order to determine a selected PUCCH format configuration.

### UE Information

As discussed above, the UE information, which may include the measurement between the UE and one or more network nodes, may be used to select PUCCH format configurations. UE information may either be received directly from the UE or calculated by the network node from other raw UE uplink measurements, such as reference signal received from the UE. Examples of UE information are as follows:

Reference Signal Received Power (RSRP) measurements for downlink or uplink reference signals, such as channel state information reference signals (CSI-RS), channel sounding reference signals (SRS), cell-specific reference signals (CRS), synchronization reference signals, such as primary and secondary synchronization reference signals (PSS, SSS, respectively) or the Synchronization Signals and PBCH Blocks (SSB or SS/PBCH block) defined by the 3GPP NR system

A measure of signal to interference and noise ratio (SINR); this value can be directly estimated by the UE and reported to the network node or be estimated at the network side using some other measurements from the UE (e.g., by using reference signals such as RSRP)

Signal attenuation measurements between the user device and one or more network node. This may include measurements of pathloss, fading, shadowing over one or multiple communication frequencies that can be used by the user device and the network node. Such measurements can be either wideband, i.e., one measurement for entire bandwidth of interest in a communication frequency, or narrow-band, i.e., multiple measurements are made in different parts of the bandwidth of interest in a communication frequency

Channel quality indicator (CQI) measurements of the communication link between the user device and the network node, such as wideband CQI or narrow band CQI measurements.

Timing advance measurement associated to the user device. In LTE and 5G systems this can be derived by the network node based on uplink measurements of random-access preamble signals during the random access procedure.

Measurements of time the signal takes to reach the network node from a user device, or to reach from the network node to user device and from user device to network node. For example, timing advance measurements or round-trip time measurements can be used for such purpose.

Type of user device, such as model, vendor, type of receiver, type of transmitter, etc. The device type could also be a parameter describing categorical information such as a mobile phone, IoT device, sensor device, vehicle, etc.

Interference measurement, either in uplink or in downlink, for the communication link between the user device and the network node, such as wideband or narrow-band interference measurements

Measurements related to location, and speed of the UE. For example, geographical positioning measurements or reference signals could be used to derive such information.

### Network Information

Some of the information available in the network side can be utilized in addition to or instead of the UE information for PUCCH format selection. The network information may include one or more of the following.

One or more network key performance indicator (KPI) associated to one or more cells of the radio network. Relevant KPI are throughput, spectral efficiency, latency, packet loss rate, call drop rate, etc. The KPI may be measured or estimated by one or more network nodes, in association to one or more radio cells. Each KPI may be represented by a single value, such as an instantaneous measurement, an average over a time window, a maximum or minimum value achieved over a time window, etc. or in statistical terms, for instance using first and second statistical moments, or a probability distribution function.

### Number of RRC Connected UEs.

Type of traffic, traffic load, QoS of the traffic and/or radio resource utilization in one or more radio cell of one or more neighboring node (i.e., interfering network node or radio cell). Examples includes: (a) a high load of VoNR/VoLTE users, (b) bursty traffic, or constant traffic flow in UL, and/or (c) DL heavy traffic, very little UL traffic.

An estimate of interference, signal propagation strength, and/or SINR from/to a network node to/from the user device.

Number of neighboring cells or radio network nodes that can interfere with the user device. In one example, a cell or radio network node is considered to be interfering with the user device if the received strength (power) of reference signals transmitted by such cell or radio network node exceed a certain threshold.

Type of neighboring cells, or radio network nodes. For instance, one may distinguish between different generation of broadband communication systems (2g, 3G, 4G, 5G, etc.) such as UMTS, HSPA, LTE, LTE-A, 5G-NR, etc. and/different releases of communication systems.

Type of traffic and/or distribution of traffic in neighboring cells or radio network nodes

Mobility related parameters, such as mobility offset setting for user device during handover, or the number of times the user device performs handover, etc.

The information regarding the location and/or speed of user device calculated by the network node based on user's related measurements (such as reference signals, or timing advance).

### PUCCH Configuration

A potential output of the PUCCH configuration algorithm or model is the possible PUCCH configurations in terms of number of symbols. The selection of PUCCH symbols is related to the certain PUCCH format (described in Error! Reference source not found., above) configurable for the UE.

The output of the algorithm may define the number of PUCCH symbols allocated to each UE individually to be used as the PUCCH. In one example, the output of the algorithm is a number within a predefined range (e.g., between 1 to 14 as of Error! Reference source not found.). In an embodiment, only a subset of available numbers within the predefined range of symbols can be selected by the algorithm. Example includes 1-2 and 4-14 as shown in Error! Reference source not found.. As such, one can control the degrees of freedom in choosing PUCCH symbols.

The symbol number may then later be directly translated into the PUCCH format based on a suitable procedure. For example, the information related to UCI payload size as well as PUCCH symbol size can be utilized to determine the final PUCCH format for the UE (as described in Error! Reference source not found.). The PUCCH format is then signaled to the UE using RRC re-configuration procedure. The PUCCH format is then utilized by the UE in sending uplink control information.

### PUCCH Format Selection Based on Exploitation Versus Exploration.

Different types of ML techniques can be used for PUCCH format selection. Examples includes reinforcement learning and contextual multi-arm bandits. Accordingly, the selection of the PUCCH format is either based on exploitation, exploration, or the combination thereof.

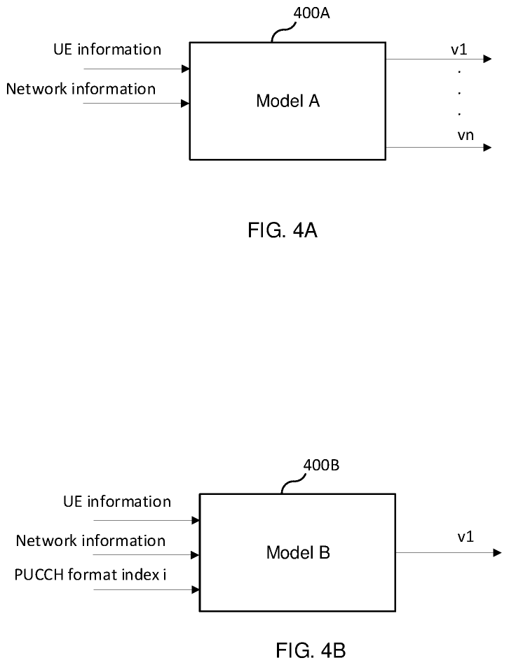

The PUCCH format selection can be exploitative. As such, the PUCCH format is computed based on an ML model available at the network node. Two examples of the model structure are shown in FIGS. 4A-B, which are each flowcharts illustrating a process according to an embodiment. Model A (400A) shown in FIG. 4A receives the UE and/or network information as inputs and computes a set of values v₁, . . . , vₙ where n denotes the total number of selectable PUCCH formats. The prediction vᵢ is a real valued function, which is the model's estimation of the value of choosing format i for the given UE and network information as input. In model B (400B) shown in FIG. 4B, the input information also includes an additional parameter i that severs as an index for a particular PUCCH format. The output parameter of the model B is then one dimensional (as opposed to model A which is n dimensional) and associates with estimated value of the model for format i. i.e., vᵢ.

One potential advantage of model B (400B) compared to Model A (400A) is its robustness against changes in the structure of the PUCCH format. In case, the number of available PUCCH formats changes then model A needs to be restructured accordingly. That means the model structure should be redesigned to include the new set of possible PUCCH formats (the output of the model changes). It is possible, however, to avoid redesigning model B, in case of such. New PUCCH formats can be introduced by using new indices fed as model B input.

In one possible implementation of the method, the ML model can be one of: a feedforward neural network, a recurrent neural network, a convolutional neural network, an ensemble of neural networks, such as feedforward neural networks, recurrent neural networks, convolutional neural networks or a combination thereof, a linear regression, or a nonlinear regression.

The selection of PUCCH format based on exploitation is a two-step procedure. First, the ML model (either model A (400A) or B (400B)) is executed to obtain the value estimate {vᵢ}_{i=1, . . . ,n}. Note that in case of model A, the value estimates are obtained at once when the model is executed. For model B, however, the model needs to be executed for all PUCCH index parameters (i=1, . . . , n). In one embodiment, the execution of model B, can be done in parallel (concurrently) for different index parameters. A second step of exploitative PUCCH format selection is then to pick the PUCCH format i* that corresponds to the maximum value estimates (i*=argmax vᵢ).

The PUCCH format selection can be explorative. In one implementation, the PUCCH format is selected uniformly at random. That is a PUCCH format is selected randomly. Such technique can be useful at the beginning when the ML model is not trained and with random exploration, one could collect initial data for the purpose of training.

Finally, the PUCCH format selection can be based on trading off exploration vs exploitation. As such, the selection of PUCCH format is based on a strategy that uses model output to exploit the knowledge acquired from previous PUCCH format selection and an exploration strategy to make sure dynamics of the network is not missed in our knowledge base (i.e., not biased toward exploiting an outdated knowledge).

In one embodiment, the network node uses an epsilon-greedy (or in short ∈-greedy) exploration strategy, wherein the network node may explore with probability ∈ and exploit with probability 1−∈, where ∈ is a parameter ranging from zero to one associated to this type of exploration strategy. In one implementation, the network node chooses a PUCCH format at random with probability ∈ or chooses a PUCCH format according to the output of the exploitative model with probability 1−∈.

In one embodiment, the network node generates a Probability Mass Function (PMF) based on ML output estimated values vᵢ. That is a set of probabilities {pᵢ}ᵢ₌₁ⁿ which represent a PMF of the available PUCCH formats. Each pᵢ takes values in the continuous interval [0, 1] (i.e., in mathematical notation pᵢ ∈ [0, 1]) and the sum of all pᵢ values is one (i.e., in mathematical notation: Σᵢ₌₁ⁿpₙ=1). As such the exploitative model returns a set of estimated values vᵢ, of which a PUCCH format is then drawn at random using the PMF {pᵢ}ᵢ₌₁ⁿ. That is the probability of choosing PUCCH format j would be pⱼ.

In one implementation, the PMF {pᵢ}ᵢ₌₁ⁿ can be calculated as the following

$${p}_{i} = \frac{{e}^{θ {v}_{i}}}{{\sum }_{k = 1}^{n} {e}^{θ {v}_{k}}} . \qquad ( 1 )$$

This is called softmax and the associated parameter θ is a design parameter determining the sensitivity of PMF values to individual estimated values vᵢ.

In another example, the network node uses a τ-first exploration strategy characterized by a parameter τ taking integer values greater or equal to one. With τ-first exploration strategy, the network node explores different PUCCH formats uniformly at random for a fixed number τ of times and selects a PUCCH format by exploiting the model afterwards.

In one embodiment, the network node uses an ensemble strategy characterized by a parameter K taking an integer value grater or equal to one. With an ensemble strategy, the network node uses an ensemble of (i.e., a number of) K exploitative models each creating a potentially different estimated PUCCH values. In one embodiment, the exploration strategy selects an exploitative model from the ensemble uniformly at random and selects the PUCCH format accordingly. This can be implemented, for instance by first picking an exploitative model uniformly at random and then the selected model produces an exploitative PUCCH format based on estimated values; that is the PUCCH format with highest value i*=argmax vᵢ.

In another embodiment, the exploration strategy selects the PUCCH format based on a voting mechanism within ensemble. In one example, each ML model in the ensemble chooses an exploitative PUCCH format. Then, the algorithm selects a PUCCH format that selected according to majority of models. In case of a tie, the final PUCCH format can be selected randomly from the ones that have maximum votes.

### Exploration Information

The information related to exploration may be utilized by the ML based PUCCH format selection method. For example, such information can be one or more of the following items.

In an embodiment, the exploration information is a parameter to determine certain exploration strategy such as epsilon-greedy or tau-first, etc.

In an embodiment, the exploration information is a parameter associated with a certain exploration strategy to be used in PUCCH format selection method. For example, information related to the epsilon greedy strategy such as ∈ value, its initial or final value, the number of PUCCH format setting steps until it reaches to final ∈ value, etc can be included.

In an embodiment, the exploration information includes information related to the trade-off between exploration and exploitation. For example, the information related to how to explore within an ensemble mechanism. For instance, a set of parameters defining whether to choose a random model for exploitation or whether to apply majority voting among exploitative PUCCH formats selected by the ensemble. As another example, the exploration information includes information characterizing a PMF function used for PUCCH format selection or parameters within the PMF function (e.g., the parameter θ in equation (1)).

In one embodiment, the exploration parameter is determined within a network node. In another embodiment, the exploration information is transmitted from a first network node to another network node and used in the second network node.

### Calculation of PUCCH Format Configuration Feedback

To evaluate the quality of the decision, a set of measurements and KPIs can be utilized. These KPIs need to be evaluated and later discarded after a certain time has passed in a sliding window fashion. The KPI is stored for a certain number of TTIs (w_{TTI}) and evaluation is based on this time window. The data evaluation is then continued within this time window, and previous data might be discarded in order to allow for reduced computational power.

In an embodiment, real value measurements can be used as means of evaluating the success or failure of the decision. In an embodiment, the feedback is computed based on a compound function of throughput and BSR. As an example, the results of the algorithm are evaluated by measuring the UL throughput of the UE together with the BSR. For instance, the feedback can be calculated as the following

$$output = \frac{throughout}{BSR}$$

To explain the property of such feedback, consider a case of non-full buffer traffic. A low throughput and high buffer status can be interpreted as an indication of congestion that might be due to low PUSCH availability and a short PUCCH allocation may be a remedy to such issue. A suitable threshold can be employed by the UE together with the feedback function in order to trigger the PUCCH reconfiguration mechanism (e.g., see t_tpt_bsr, above).

As another example, the results of the algorithm are evaluated by measuring the amount of PRBs scheduled in one or more cells (e.g., PRB utilization metric) and/or the number of available physical resources in downlink control channel allocated for uplink scheduling grants. As such, one could conclude information about the congestion from mentioned measurements; For example, consider a case of non-full buffer traffic. A high value of PRB utilization (a value close to 1 or 100%) and/or PDCCH block rate (a measurement indicating how often PDDCCH resources are fully occupied) can be interpreted as an indication of highly congested situation that might be due to low PUSCH availability and a short PUCCH allocation may be a remedy to such issue. A suitable threshold can be employed by the UE together with the feedback function in order to trigger the PUCCH reconfiguration mechanism (e.g., see t_congestion, above).

In one embodiment, the DTX rate can be utilized to measure the coverage improvements of the PUCCH, decreased DTX rate can indicate improved PUCCH coverage. As an example, in the case of high VONR/VOLTE traffic, assume the decision is to use short PUCCH because the UE was initially in the vicinity of the gNB. The UE continues to send the information to gNB with high throughput, but at some point, the UE is in a high distance from the gNB. In this scenario, the increased throughput will not yield high quality for the user, and coverage requirements are more important than higher throughput. Hence, long PUCCH allocation is of higher importance.

An illustrative example of how these outputs can be calculated is given by the following algorithm for the DTX rate evaluation:

for t = 0: w_{TTI}
if (Δ DTXᵣₐₜₑ > ∈ && PUCCH_{format} == short)
output = Failure
else
output = Success

In another embodiment, the quality of service provided is used as a way of evaluating the decision quality. As an example, for VONR/VOLTE services, the number of dropped calls or user satisfaction rate can be one such metrics. In other cases, the BLER, as an indication of the packet drops can be utilized as a metric for evaluating the PUCCH choice.

In one embodiment, the evaluation of the quality of decision is assessed by a binary KPI as Success vs Failure. This KPI is defined based on a function, weighing the different set of outputs as mentioned in previous embodiments and generates the binary output. As an example, a function is defined for weighing as:

$$output = w 1 \times \frac{throughput}{B S R} + w 2 \times Δ {DTX}_{rate} , w 1 + w 2 = 1$$

the parameter output then defines the success or failure if the output value is compared against a suitable threshold; that is results is Success if output>threshold and result is Failure if output<threshold.

### Learning the PUCCH Format Selection Algorithm

In one embodiment, the network node further learns (trains or updates) the (exploitative) ML model for selecting the PUCCH format with user devices based on some historical data, where each data sample of the historical data is associated to a PUCCH format configured for the UE.

Historical data samples collected upon selection of PUCCH format for different user devices may be used to train the exploitative model. The data samples could be collected from one or more radio cells controlled by the network node.

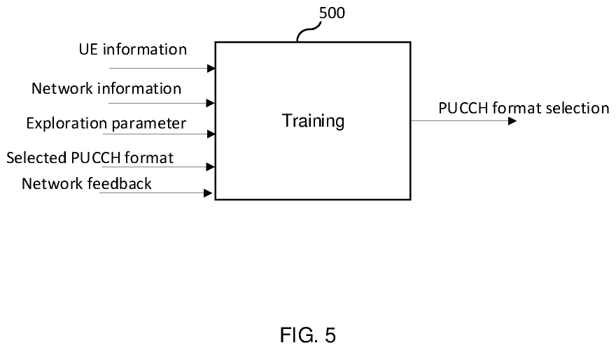

FIG. 5 is a flowchart illustrating a process according to an embodiment. As shown in FIG. 5, the data samples collected for training the ML model (500) for PUCCH format selection may include: (1) UE information: one or more UE measurements used to select a PUCCH format for the UE, (2) Network information used for configuring a PUCCH format for the UE, (3) The PUCCH format (or an index representing the PUCCH format) selected for the same UE, (4) One or more parameters related to the exploration strategy used at the time of selecting a PUCCH format for the UE. This include, for example, the probability value associated to the selected PUCCH format for the UE. Or the value of e in epsilon-greedy strategy at time when PUCCH format was selected for the UE. (5) The network feedback associated to the selected PUCCH format for the UE.

In an embodiment, the network node may further: (1) Transmit a request for historical data to the second network node associated to the task of PUCCH format selection; (2) Receive from a second network node a set of for historical data associated to the same task, and (3) Train/update the explorative model based on the set of historical data and/or data stored at the network node

As such, the network node requests data samples from a second network node. The second network node could maintain a storage unit for data collected by the network node. In addition, the second network node may further store data samples collected by other network nodes. In this case, the network node may therefore train a model with data collected by other network nodes, e.g., in other radio cells not controlled by the network node. This allows to increase the diversity of the data samples and therefore improve the generalization capacity of the model.

In an embodiment, the network node may further receive from a second network node one or more updated models for the task of PUCCH format selection for a user device. In this case, it is the second network node that trains/determines/updates the exploitative model using historical data associated to the mentioned task. Suitable model structures (such as neural networks, etc.) are described above that can be trained for selecting PUCCH format. In case the network node uses an ensemble of more than one model, the second network node may transmit one or more exploitative models to the network node.

In an embodiment, the network node may further request one or more models from a second network node.

In an embodiment, the network node may receive one or more models from a second network node and further trains it with local data samples. That is to update/improve the received model with data samples that are not used previously to train the original model. In this way, the network node can further improve the performance of PUCCH format selection by improving the received model by the data samples that are collected locally from the radio cell(s). Moreover, the received model plays the role of warm-starting for the network node, as it provides an exploitative model for the network node that usually outperforms an initial exploitative policy which randomly selects PUCCH formats.

### Training of ML Model Utilized for PUCCH Format Selection

The training data described above includes training data collected from history of PUCCH format selection for the UE as well as signaling and mechanisms associated to the network node(s) that training takes place. Below are example methods that can be used to train an (exploitative) ML model for PUCCH format selection.

In one embodiment, the parameters of the PUCCH selection model (e.g., weights of an artificial neural network, support vector machine, non-linear regression model) are calculated or updated using suitable optimization techniques. The process of updating model parameters are generally referred as training.

Below are three examples in which exploitative models are utilized.

According to one embodiment, the network node determines an exploitative PUCCH format based on a model. As such, the computation for selecting an exploitative PUCCH format can be parameterized as the following

$$P U C C {H}_{t} = arg {max}_{{\{ P U C C {H}_{i} \}}_{i = 1}^{n}} {v}_{i} = f ( x , i , w ) \qquad ( 2 )$$

In which ƒ(⋅) is an estimated value function of model parameters w and input features x and a PUCCH index i. The function ƒ(⋅) is calculated/updated in the training process. The input to the model is a set represented by x which contains network and user information associated with the PUCCH format selection for the UE. In case of model structure B (see FIG. 4B) the model is provided by an additional input i which denotes a PUCCH index in the set of possible PUCCH formats; i.e., i=1, . . . , n. If the model is of type A (see FIG. 4A) then the parameter i=1, . . . , n denotes the components of the output estimated value function vᵢ. According to eq. (2) the selection of the PUCCH format at time t is the PUCCH index that has highest estimated value.

According to a second embodiment, the network node determines a PMF function of PUCCH formats. As such, the computation for the PUCCH format can be of the presented in the following form:

$${\{ {p}_{i} \}}_{i = 1}^{n} = \frac{{e}^{θ {v}_{i}}}{{\sum }_{k = 1}^{n} {e}^{θ {v}_{k}}} , {\{ {v}_{i} \}}_{i = 1}^{n} = f ( x , {\{ i \}}_{i = 1}^{n} , w )$$

In which the prediction function ƒ(⋅) and its associated parameters w are calculated/updated in the training process. The estimated values {vᵢ}ᵢ₌₁ⁿ corresponds to the predicted KPI (reward) values for different PUCCH formats potentially configurable for a UE. The output of the exploitative model is then a SoftMax operator {pᵢ}ᵢ₌₁ⁿ with a suitably selected scalar θ. Note that SoftMax operator takes the functional values {vᵢ}ᵢ₌₁ⁿ as input and returns a probability simplex; i.e.,

$${p}_{i} ∈ [ 0 , 1 ] , {\sum }_{i = 1}^{n} {p}_{i} = 1 .$$

In above example, the PMF function {pᵢ}ᵢ₌₁ⁿ is then utilized to select a PUCCH format (i.e., to sample a PUCCH format according to the PMF).

According to a third embodiment, the function ƒ(xₜ, iₜ, wₖ) may represent an estimated value function associated to specific user and network information as well as a specific PUCCH format. For example, in q-learning the ƒ(xₜ, iₜ, wₖ) represents the state and action value function (or q-value function q(xₜ, iₜ) parameterized by the parameters vector wₖ where k represents an index for times that models is updated (trained). Further, xₜ represents the state features and iₜ represents an action taken by the agent (PUCCH format selection algorithm) at sample (time interval) t. The selection of the PUCCH format according to q-learning based algorithms can be formulated a

$$P U C C {H}_{t} = \{ \begin{matrix}arg {max}_{{\{ PUCC {H}_{i} \}}_{i = 1}^{n}} q ( {x}_{t} , i , {w}_{k} ) & with p rob . 1 - ϵ \\ select a random PUCCH format & othe r w i s e\end{matrix}$$

The ∈∈[0,1] is the exploration parameter, which typically starts from 1 and decays gradually towards 0 ensuring to provide a trade-off between exploration and exploitation.

### Training Algorithms for PUCCH Format Selection

Below are algorithmic details of example methods used for training an exploitative model. One then needs to put iₜ into the context of exploitative model examples presented above to see how a trained model is utilized for PUCCH selection. Essentially, training of the exploitative model can be formulated as a mathematical optimization problem of the following for

$$v = arg {min}_{w} {\sum }_{t = 1}^{T} {α}_{t} ℓ ( f ( {x}_{t} , {i}_{t} , w ) , {r}_{t} ) + g ( w ) \qquad ( 3 )$$

Where t=1, . . . , T denotes the number of training samples (the number of PUCCH format selection samples that network node has at its training data), rₜ is the measured KPI (or a function of iₜ) collected after configuring a PUCCH format for the UE. The term [symbol] (ƒ(⋅), r) represents the loss function in the optimization problem and can take various forms. Examples include the squared loss [symbol] (ƒ(⋅), r)=(ƒ(⋅)−r)² and hinge loss in support vector machines [symbol] (ƒ(⋅), r)=max(0,1−ƒ(⋅)r), to name a few.

The term ƒ(xₜ, iₜ, wₖ) is a prediction function in which xₜ denotes the input information associated with PUCCH selection sample t, iₜ is the PUCCH format selected by the network node at sample t and w represents the exploitative model parameters.

In an embodiment of the invention, the function ƒ(xₜ, iₜ, wₖ) represents an estimated state and action value function. For example, in q-learning the ƒ(xₜ, iₜ, wₖ) represents the state and action value function (or q-value function q(xₜ, iₜ) parameterized by the parameters vector wₖ. As such, xₜ represents the state features and iₜ represents an action taken by the agent (PUCCH format selection algorithm) at sample (time interval) t. Various RL algorithms can be applicable here. For example, in q-learning based algorithms (e.g., Deep Queue Networks (DQN)), training of the q-network (the neural network that estimates the q-value) can be formulated as the following.

$$ℓ ( f ( \cdot ) , r ) = {( f ( {x}_{t} , {i}_{t} , {w}_{k} ) - y )}^{2} , y = r + γ {max}_{{i}_{t}} f ( {x}_{t}^{′} , {i}_{t}^{′} , \overline{w} )$$

where r represents the feedback of selecting PUCCH format iₜ for state feature xₜ, γ ∈ (0,1) is a scalar value referred as the discount factor, x′ₜ is the state feature (the UE and network information) after selection of PUCCH format iₜ, and w̅ is the weight parameter of the neural network which typically is set form historical parameter value (value of neural network weights from an earlier time than wₖ). The function that q-value is trying to estimate is y which is referred as the target value. It follows the Bellman identity equation and can be interpreted as the value (feedback) that agent receives from selecting current PUCCH format as well as the (discounted) estimated value of next best PUCCH format configuration (i.e., selecting the PUCCH format for the next UE and network information that has highest estimated q-value). By progressively training and updating q-value estimates, the q-learning based algorithms optimize a greedy-policy aiming at satisfying the Bellman identity in the equilibrium; that is finding the optimal weights w* such that the following holds

$$f ( {x}_{t} , {i}_{t} , {w}^{⋆} ) = r + {max}_{{i}_{t}} f ( {x}_{t}^{′} , {i}_{t}^{′} , {w}^{⋆} ) .$$

The parameter αₜ in (3) is a positive scalar value which represents a weight on individual training samples. In one example, at is proportional to the inverse of the probability pₙ in which PUCCH format i was selected by the network node at sample t. That is

$${α}_{t} = \frac{1}{{p}_{i}} .$$

In another example, α is a measure of sample importance, i.e., how important is the current sample t in relation to other samples. In one example, prioritized experience replay is considered in training of q-learning based algorithms. Standard q-learning algorithms would use batches of training data that are sampled uniformly at random, where each sample has equal probability of being selected. It is possible, however, to assign non-uniform distribution over training samples. In one example, one would assign weights on different training samples relative to their so-called Temporal Difference (TD) error, that is

$${α}_{t} ∼ \vert f ( {x}_{t} , {i}_{t} , {w}_{k} ) - r - γ {max}_{{i}_{t}} f ( {x}_{t}^{′} , {i}_{t}^{′} , \overline{w} ) \vert .$$

As shown in previous examples, the function ƒ(xₜ, iₜ, w) estimates the network KPI, reward, or a value function for any given input x and PUCCH format i. The parameters w is then trained to fit estimation function ƒ(⋅) best to the available training samples collected from PUCCH selection instances available as training data.

The regularization term g(w) is sometime added to the optimization problem (3) to introduce certain properties to the problem or to the structure of model parameters. For example, g(w)=λ∥w∥₂² is an [symbol] ₂-norm regularization term parametrized by a scalar λ>0 introduces smoothness properties leading to improved convergence of numerical algorithms that solve the optimization problem for training. In another example, g(w)=λ∥w∥₁ is an [symbol] ₁-norm regularization which favors sparse solutions of model parameters w thereby reducing the risk of overfitting.

Above optimization problem for training, i.e., minimizing the loss function with respect to exploitative model parameters w, can be solved using suitable numerical optimization algorithms including variants of gradient descent, gradient method with momentum (e.g., adam, adagrad, etc), BFGS, or higher order methods such as Newton.

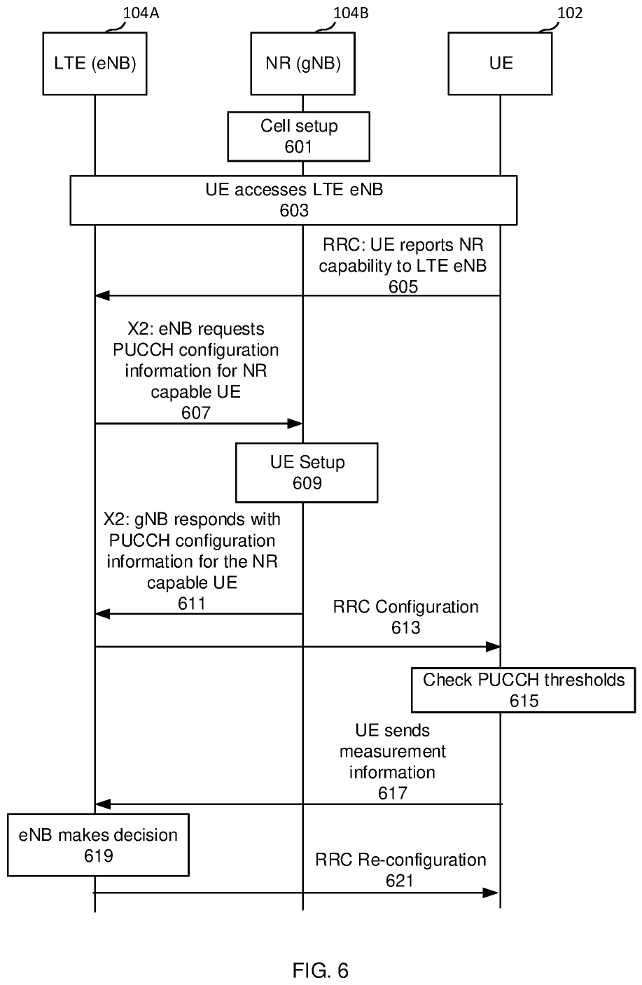

FIG. 6 is a flowchart illustrating a process according to an embodiment. FIG. 6 illustrates a signaling diagram among a UE 102 and network nodes eNB 104A and gNB 104B. At 601, a call is set up in the NR gNB 104B. At 603, the UE accesses the LTE eNB 104A. At 605, the UE transmits a RRC message reporting its NR capability to the LTE eNB 605. At 607, the LTE eNB (104A) requests PUCCH configuration information from the NR gNB 104B for the NR capable UE 102. At 609, the NR gNB initiates a UE setup. At 611, the gNB transmits PUCCH configuration information for the NR capable UE to the eNB. At 613, the eNB transmits a RRC configuration message to the UE. At 615, the UE checks PUCCH thresholds, as discussed above. At 617, the UE transmits measurement information to the eNB (e.g., if one or more PUCCH thresholds are met or exceeded as discussed above). At 619, the eNB determines if the PUCCH format configuration should be updated (e.g., using the ML model discussed above). If the PUCCH format configuration should be updated, at 621, the eNB transmits a RRC re-configuration message 621 to the UE indicating the new PUCCH format configuration.

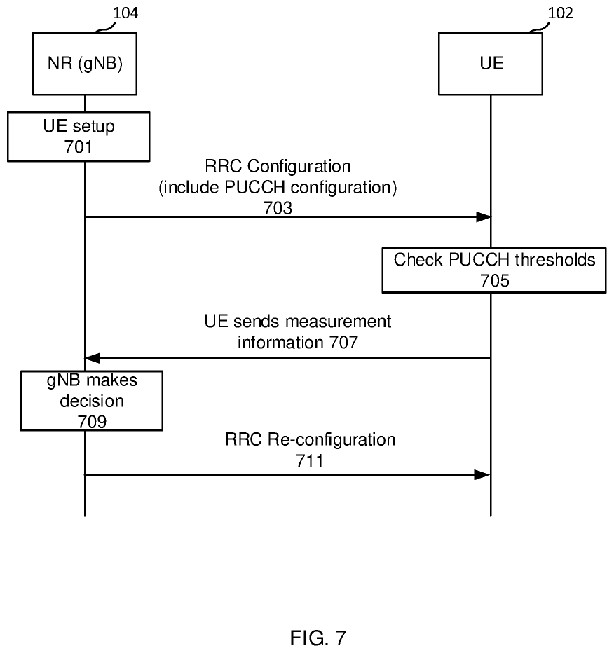

FIG. 7 is a flowchart illustrating a process according to an embodiment. FIG. 7 illustrates a signaling diagram among a UE 102 and network nodes gNB 104. At 701, the gNB initiates a UE setup procedure. At 703, the gNB transmits a RRC Configuration message to the UE, the message comprising a PUCCH configuration. At 705, the UE checks PUCCH thresholds as described above. At 707, the UE transmits measurement information to the gNB, e.g., if one or more PUCCH thresholds are exceeded. At 709, the gNB makes a decision as to whether to update the PUCCH format configuration for the UE. If yes, at 711, the gNB transmits a RRC re-configuration message to the UE with a new PUCCH format configuration.

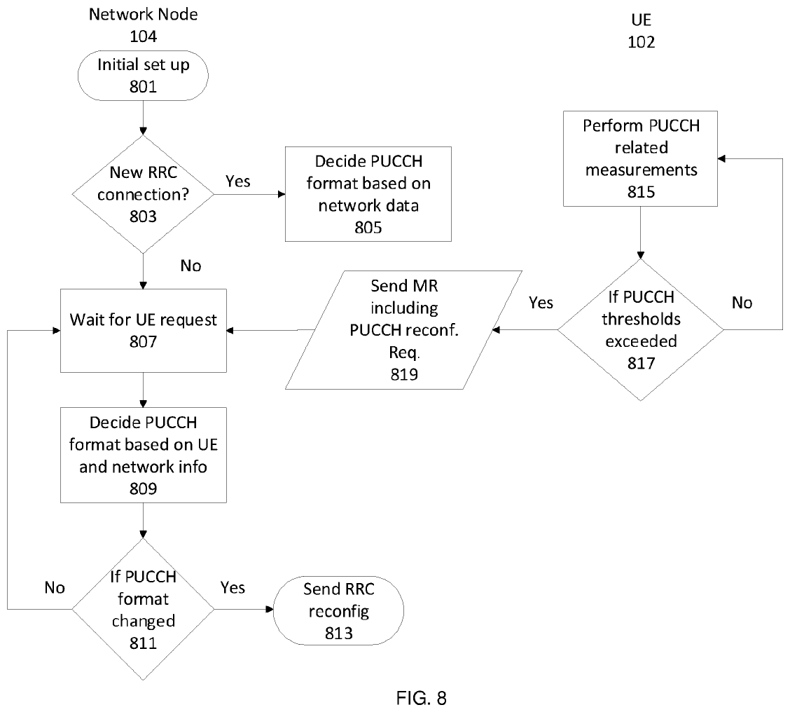

FIG. 8 is a flowchart illustrating a process according to an embodiment. In some embodiments, steps 801, 803, 805, 807, 809, 811, and 813 may be performed by a network node 104, and steps 815, 817, and 819 may be performed by a UE. At step 801, the network node 104 performs an initial setup of the UE 102. At step 803, the network node 104 evaluates if iₜ needs to establish a new RRC connection with the UE. If yes, at 805 the network node 104 determines a PUCCH format configuration based on network data. If no, at 807, the network node 104 waits for a PUCCH reconfiguration request from the UE. At 815, the UE 102 may perform PUCCH related measurements as described above, and at 817, the UE determines if one or more PUCCH thresholds have been exceeded. If no, the UE repeats PUCCH related measurements at 815. If yes, at 819 the UE transmits to the network node 104 a PUCCH reconfiguration request, which may include a measurement report. At 809, the network node 104 may determine a suitable PUCCH configuration format based on the UE and/or network information (e.g., using the ML algorithm(s) described above). At 811, the network node determines if the PUCCH format changed, e.g., if the UE's current PUCCH format is different than the determined PUCCH format at 809. If yes, the network node 104 transmits a RRC reconfiguration message towards the UE with the new PUCCH format configuration. If no, the network node returns to 807 and waits for a PUCCH reconfiguration request from the UE.

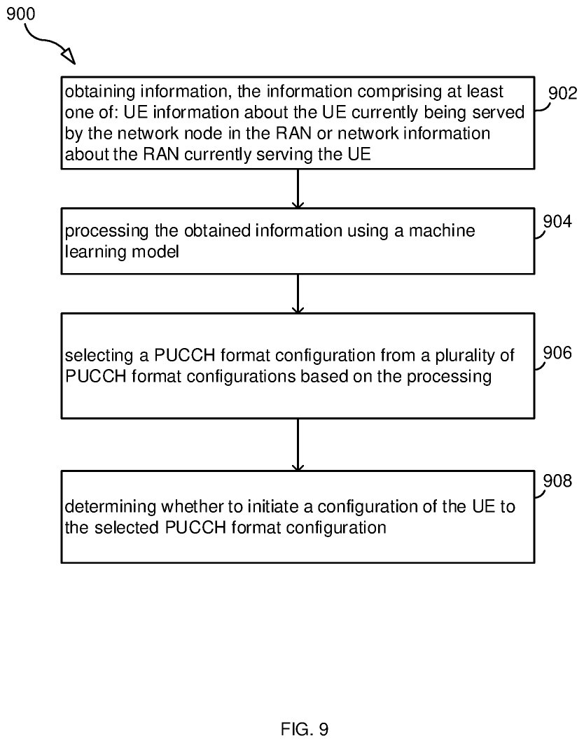

FIG. 9 is a flowchart illustrating a process (900) according to an embodiment. The process (900) may be performed in a radio access network (RAN) for Physical Uplink Control Channel (PUCCH) format configuration of a user equipment (UE) currently being served by a network node in the RAN. In some embodiments, process 900 is performed by the network node. At step 902, information is obtained, the information comprising at least one of: UE information about the UE currently being served by the network node in the RAN or network information about the RAN currently serving the UE. At step 904, the obtained information is processed using a machine learning model, such as one or more of the models described above and in connection with FIGS. 3, 4A-B, and 5. At step 906, a PUCCH format configuration is selected from a plurality of PUCCH format configurations based on the processing. At step 908, it is determined whether to initiate a configuration of the UE to the selected PUCCH format configuration.

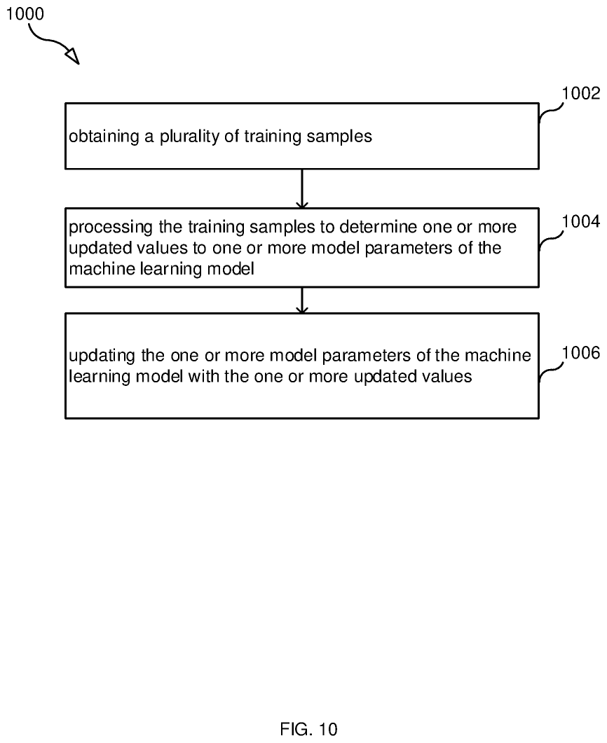

FIG. 10 is a flowchart illustrating a process (1000) according to an embodiment. The process (1000) may be performed in a radio access network (RAN) for training a machine learning model (such as models 300, 400A, 400B, and/or 500) to select a Physical Uplink Control Channel (PUCCH) format configuration of a user equipment (UE) currently being served by a network node in the RAN. At step 1002, a plurality of training samples is obtained. In some embodiments, each training sample comprises: a selected PUCCH format selection, input information comprising at least one of: UE information about the UE or network information about the RAN, a measured key performance indicator (KPI) after configuring the UE with the PUCCH format selection, and one or more parameters related to an exploration strategy used at a time of selection of the selected PUCCH format selection. At step 1004, the training samples are processed to determine one or more updated values to one or more model parameters of the machine learning model. At step 1006, the one or more model parameters of the machine learning model are updated with the one or more updated values.

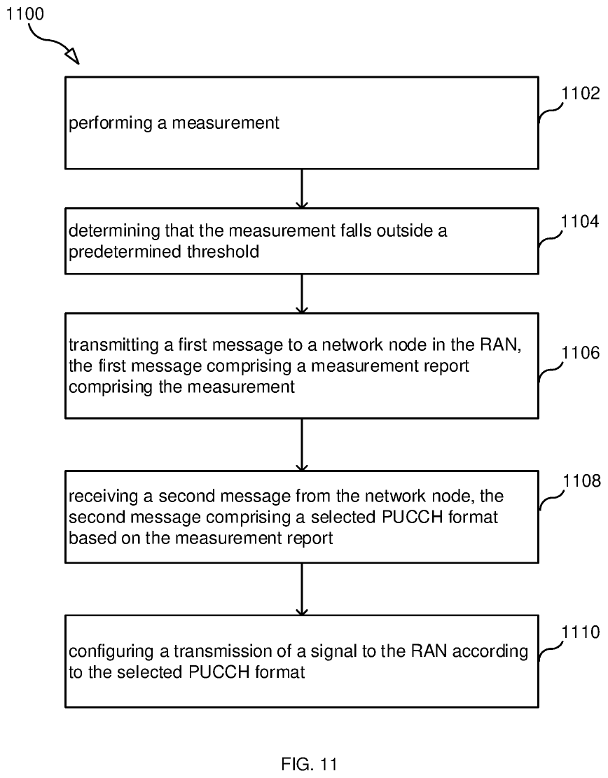

FIG. 11 is a flowchart illustrating a process (1100) according to an embodiment. The process (1100) may be performed by a user equipment (UE) in a radio access network (RAN) for Physical Uplink Control Channel (PUCCH) format configuration of the UE. At step 1102, the a measurement is performed. At step 1104, it is determined that the measurement falls outside a predetermined threshold. At step 1106, a first message is transmitted to a network node in the RAN, the first message comprising a measurement report comprising the measurement. At step 1108, a second message is received from the network node, the second message comprising a selected PUCCH format based on the measurement report. At step 1100, a transmission of a signal to the RAN is configured according to the selected PUCCH format.

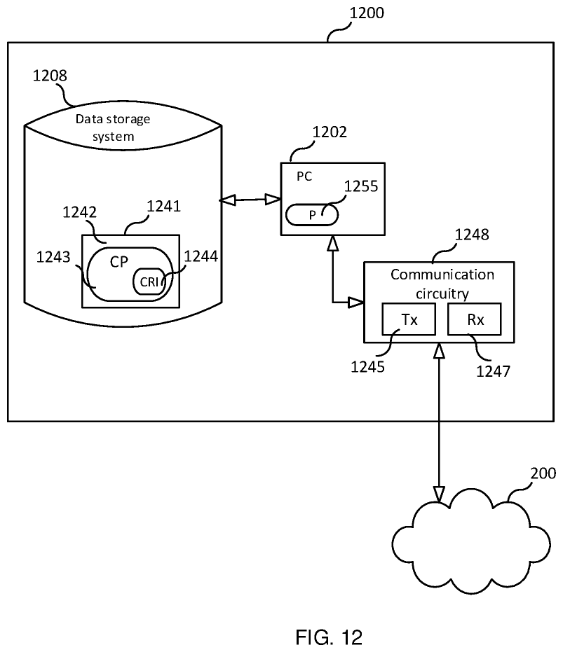

FIG. 12 is a block diagram of an apparatus according to an embodiment. In some embodiments, apparatus 1200 may be one of a UE 102 or a network node 104. As shown in FIG. 12, apparatus 1200 may comprise: processing circuitry (PC) 1202, which may include one or more processors (P) 1255 (e.g., one or more general purpose microprocessors and/or one or more other processors, such as an application specific integrated circuit (ASIC), field-programmable gate arrays (FPGAs), and the like); communication circuitry 1248, comprising a transmitter (Tx) 1245 and a receiver (Rx) 1247 for enabling apparatus 1200 to transmit data and receive data (e.g., wirelessly transmit/receive data); and a local storage unit (a.k.a., “data storage system”) 1208, which may include one or more non-volatile storage devices and/or one or more volatile storage devices. In embodiments where PC 1202 includes a programmable processor, a computer program product (CPP) 1241 may be provided. CPP 1241 includes a computer readable medium (CRM) 1242 storing a computer program (CP) 1243 comprising computer readable instructions (CRI) 1244. CRM 1242 may be a non-transitory computer readable medium, such as, magnetic media (e.g., a hard disk), optical media, memory devices (e.g., random access memory, flash memory), and the like. In some embodiments, the CRI 1244 of computer program 1243 is configured such that when executed by PC 1202, the CRI causes apparatus 1200 to perform steps described herein (e.g., steps described herein with reference to the flow charts). In other embodiments, apparatus 1200 may be configured to perform steps described herein without the need for code. That is, for example, PC 1202 may consist merely of one or more ASICs. Hence, the features of the embodiments described herein may be implemented in hardware and/or software.

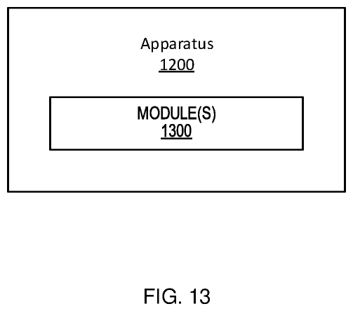

FIG. 13 is a schematic block diagram of the apparatus 1200, according to an embodiment. The apparatus 1200 includes one or more modules 1300, each of which is implemented in software. The module(s) 1300 provide the functionality of apparatus 1300 described herein (the steps herein, e.g., with respect to the process figures).

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### ABBREVIATIONS

PUCCH Physical Uplink Control Channel
PUSCH Physical Uplink Shared Channel
PDCCH Physical Downlink Control Channel
HARQ Hybrid Automatic Repeat Request
SR Scheduling Request
PMI Precoding Matrix Index
CSI Channel State Information
UCI Uplink Control Information
RL Reinforcement Learning
TDM Time Division Multiplex
PRB Physical Resource Block
CQI Channel Quality Indicator
RI Rank Indicator
URLLC Ultra-Reliable Low Latency Communication
KPI Key Performance Indicator

1. A method performed in a radio access network (RAN) for Physical Uplink Control Channel (PUCCH) format configuration of a user equipment (UE) currently being served by a network node in the RAN, the method comprising:
obtaining information, the information comprising at least one of: UE information about the UE currently being served by the network node in the RAN or network information about the RAN currently serving the UE;
processing the obtained information using a machine learning model;
selecting a PUCCH format configuration from a plurality of PUCCH format configurations based on the processing; and
determining whether to initiate a configuration of the UE to the selected PUCCH format configuration.

2-3. (canceled)

4. The method of claim 1, further comprising:
transmitting a message to initiate a configuration of the UE to the selected PUCCH format configuration.

5-6. (canceled)

7. The method of claim 1, wherein the UE information comprises one or more of:
a reference signal received power (RSRP) measurement for an uplink or downlink reference signal;
information indicating a measurement of signal to interference and noise ratio (SINR);
a signal attenuation measurement between the UE and the network node;
channel quality indicator (CQI) measurement of a communication link between the UE and the network node;
an indication of a timing advance measurement associated to the UE;
a measurement of a time a signal takes to reach the network node from the UE;
a measurement of a round-trip time a signal takes to reach the network node from the UE and from the UE to the network node;
a type of the UE device;
an interference measurement in the uplink or downlink communication link between the UE and network node; and
a measurement related to a location and/or speed of the UE.

8. The method of claim 1, wherein the network information comprises one or more of:
a network key performance indicator associated to one or more cells of the RAN;
a number of UEs connected to the RAN;
information indicating a type of network traffic, a traffic load, a quality of service, and/or a radio resource utilization in one or more cells of the RAN;
an estimate of interference, signal propagation strength, and/or signal to interference and noise ratio (SINR) of a communication link between the network node and the UE;
a number of neighboring cells or network nodes that can interfere with the UE;
a type of neighboring cells or network nodes;
a type of traffic and/or distribution of traffic in neighboring cells or network nodes;
one or more mobility related parameters; and
information regarding a location and/or speed of the UE.

9. The method of claim 1, wherein the selecting the PUCCH configuration format comprises:
obtaining an output from the machine learning model, wherein the output indicates the selected PUCCH format configuration.

10. The method of claim 1, wherein the selecting the PUCCH configuration format comprises:
selecting a PUCCH format randomly from the plurality of PUCCH formats.

11. (canceled)

12. The method of claim 9, wherein the output comprises a prediction for a PUCCH format configuration.

13. (canceled)

14. The method of claim 9, wherein the output comprises a set of predictions of each of the PUCCH formats of the plurality of PUCCH formats.

15. The method of claim 14, wherein each prediction corresponds to a numeric value and the selecting the PUCCH format comprises:
selecting a PUCCH format corresponding to a prediction having a highest numeric value.

16. The method of claim 14, wherein the selecting the PUCCH format comprises:
selecting a PUCCH format according to a probability mass function PMF {pᵢ}ᵢ₌₁ⁿ,
wherein pᵢ is a prediction for a PUCCH format of the plurality of PUCCH formats {pᵢ}ᵢ₌₁ⁿ, wherein pᵢ ∈ [0, 1]) and Σᵢ₌₁ⁿpₙ=1.

17. The method of claim 16, wherein the probability mass function is calculated using:
$${p}_{i} = \frac{{e}^{θ {v}_{i}}}{{\sum }_{k = 1}^{n} {e}^{θ {v}_{k}}}$$
wherein θ is a design parameter determining a sensitivity of PMF values to individual predictions vᵢ for a PUCCH format configuration.

18. (canceled)

19. The method of claim 1, further comprising:
obtaining one or more measurements of the UE or a communication channel between the UE and the network node from the UE after the UE has been configured with the selected PUCCH format configuration; and
determining a success or failure of the selected PUCCH format based on the one or more measurements.

20. The method of claim 19, wherein the one or more measurements comprises one or more of:
a traffic throughput of the communication channel between the UE and the network node;
a buffer-status report (BSR) of the UE;
an amount of physical resource blocks (PRBs) scheduled in one or more cells of the RAN;
a number of physical resources in downlink control channel allocated for uplink scheduling grants; or
a discontinuous transmission (DTX) rate.

21. The method of claim 19, further comprising:
updating the machine learning model based on the determining the success or failure of the selected PUCCH format or a success or failure of one or more selected PUCCH formats.

22. A method performed in a radio access network (RAN) for training a machine learning model to select a Physical Uplink Control Channel (PUCCH) format configuration of a user equipment (UE) currently being served by a network node in the RAN, the method comprising:
obtaining a plurality of training samples, wherein each training sample comprises a selected PUCCH format selection,
input information comprising at least one of: UE information about the UE or network information about the RAN,
a measured key performance indicator (KPI) after configuring the UE with the PUCCH format selection, and
one or more parameters related to an exploration strategy used at a time of selection of the selected PUCCH format selection;
processing the training samples to determine one or more updated values to one or more model parameters of the machine learning model; and
updating the one or more model parameters of the machine learning model with the one or more updated values.

23. The method of claim 22, further comprising:
applying the machine learning model with the updated one or more model parameters to select a PUCCH format configuration for the UE.

24. The method of claim 22, wherein the processing comprises performing an optimization according to
$$v = arg {min}_{w} {\sum }_{t = 1}^{T} {α}_{t} ℓ ( f ( {x}_{t} , {i}_{t} , w ) , {r}_{t} ) + g ( w )$$
where t=1, . . . , T denotes the number of training samples,
rₜ is the measured KPI, [symbol]
(ƒ(⋅), r) is a loss function,
ƒ(xₜ, iₜ, wₖ) is a prediction function in which xₜ is the input information associated with a training sample t, iₜ is the PUCCH format selection for training sample t, and w represents the one or more model parameters,
αₜ is a positive scalar value representing a weight on an individual training sample, and
g(w) is a regularization term.

25. The method of claim 24, wherein the loss function comprises a squared loss function or a hinge loss in support vector machines.

26. The method of claim 24, wherein the prediction function represents an estimated state and action value function where xₜ represents a state feature and iₜ represents a PUCCH format selection model at time interval t.

27. The method of claim 24, wherein αₜ is proportional to the inverse of a probability pₙ in which a PUCCH format i was selected by the network node at sample t.

28. A method performed by a user equipment (UE) in a radio access network (RAN) for Physical Uplink Control Channel (PUCCH) format configuration of the UE, the method comprising:
performing a measurement;
determining that the measurement falls outside a predetermined threshold;
transmitting a first message to a network node in the RAN, the first message comprising a measurement report comprising the measurement;
receiving a second message from the network node, the second message comprising a selected PUCCH format based on the measurement report; and
configuring a transmission of a signal to the RAN according to the selected PUCCH format.

29. (canceled)

30. (canceled)

31. The method of claim 28, wherein the measurement comprises a difference between two consecutive reference signal received power (RSRP) measurements.

32. The method of claim 28, wherein the measurement comprises a measure of throughput combined with a buffer status report.

33. The method of claim 32, wherein the predetermined threshold comprises a first threshold for the measure of throughput and a second threshold for the buffer status report, and the determining comprises one of:
determining that the measure of throughput is below the first threshold and the buffer status report is greater than the second threshold, or
determining that the measure of throughput is greater than the first threshold and the buffer status report is lower than the second threshold.

34. The method of claim 28, wherein the measurement comprises an indication of congestion.

35-42. (canceled)
